(19) United States
(12) Patent Application Publication
(10) Pub. No.: US 2007/0281190 A1
(43) Pub. Date: Dec. 6, 2007

(54) Fuel cell arrangement and device for mounting a fuel cell arrangement on a housing

(75) Inventor: Michael Stelter, Chemnitz (DE)

Correspondence Address: ROBERTS, MLOTKOWSKI & HOBBES, P. O. BOX 10064, MCLEAN, VA, 22102-8064, US

(73) Assignee: Webasto AG, Stockdorf (DE)

(21) Appl. No.: 10/565,807

(22) PCT Filed: Jul. 23, 2004
(86) PCT No.: PCT/DE04/01640

§ 371 Date: Jan. 25, 2006

(30) Foreign Application Priority Data
Jul. 25, 2003 (DE) 103 34 130.7

(51) Int. Cl. H01M 8/24

(52) U.S. Cl. 429/18

(57) ABSTRACT

A fuel cell array comprising a fuel cell stack (12) with several fuel cells (10) and a first (14) and a second end plate (16) defining the fuel cell stack (12) on the end thereof, and a device for fixing the fuel cell array to a housing (38). At least one force transmitting device (18) is provided which transmits a first force to the first end plate (14) in the direction of the second end plate (16) and a second force to the second end plate (16) in the direction of the first end plate (14). An elastic arrangement (20) is involved in the transmission of force.

### BACKGROUND OF THE INVENTION

1. Field of the Invention

The invention relates to a fuel cell arrangement with a fuel cell stack which encompasses several fuel cells and a first and a second end plate which border the fuel cell stack on the ends of the stack.

The invention furthermore relates to a device for mounting a fuel cell arrangement on a housing.

2. Description of Related Art

These arrangements are known and are used, for example, in SOFC fuel cells (“solid oxide fuel cell”). Since the voltage delivered by the fuel cell is fixed by the electrochemical processes in the fuel cell, several series-connected fuel cells are used in order to make available a multiple of this voltage, the stacking of the individual fuel cells consisting of an anode, electrolyte and cathode on top of one another having proven itself.

In this stacking of fuel cells on top of one another, problems arise especially in connection with the mechanical stability of the fuel cell stack. Providing sufficient stability is of fundamental importance and is especially important particularly in mobile applications, for example, in the motor vehicle domain.

Numerous approaches to increasing the stability of fuel cell stacks are known. They include the cementing of the individual stack layers, for example, by glass paste, and application of an external force to the stack ends, i.e., especially to the end plates, of the fuel cell stack. The use of detachable, compressible seals between the individual layers and additionally the application of a force from the outside to the stack ends are likewise known.

These and other approaches to increasing the stability of fuel cells are suited to solving component problems of the fundamental problem of stability, but they are not able to provide satisfactory mechanical loadability of the fuel cell arrangements. For example, cemented fuel cell stacks can be damaged by vibrations; this can lead to their falling apart at temperatures above 800° C. These temperatures are easily reached in operation of SOFC fuel cells. Compressible seals which are compressed by rigid external bracing often do not seal satisfactorily.

### SUMMARY OF THE INVENTION

The object of the invention is to at least partially overcome the aforementioned problems and especially to make available a fuel cell arrangement which imparts improved stability properties to the arrangement.

This object is achieved by the provision of at least one energy transmission means which transmits a first force to a first end plate in the direction of a second end plate and a second force to the second end plate in the direction of the first end plate, elastic means being involved in the energy transmission. The individual fuel cell elements can thus be stacked without special precautions and can be provided with end plates on their stack ends. Mechanical stability is provided by the energy transmission to the end plates, advantageous mechanical properties with respect to possible vibrations being created by the elastic means participating in energy transmission.

The fuel cell arrangement in accordance with the invention is advantageously developed in that the fuel cell stack and the end plates have at least one through opening which extends essentially perpendicular to the end plates, that in at least one through hole there is an energy transmission element which projects beyond the upper and lower end plate, that the energy transmission element on the area projecting beyond the first end plate has a first energy absorption area or is connected to one which is supported directly or indirectly on the first end plate, and that the energy transmission element on the area projecting beyond the second end plate has a second energy absorption area or is connected to one which applies a force to the second end plate by way of the elastic means. In order to provide sufficient mechanical stability together with a certain elasticity, it is enough to apply a force to the two end plates by way of elastic means while a rigid counterforce can be applied to the other end plate.

It is advantageously provided that the energy transmission element has an essentially cylindrical segment which is located partially within the through opening, that the first energy absorption area is made as a cover plate of the cylindrical segment and has a greater radius than the through opening through the first end plate, and that the second energy absorption area is an end ring which surrounds the cylindrical segment and which is connected to it, the end ring can be made in several parts. The energy transmission means is thus made in the manner of a tie rod which can be inserted into a through opening until it directly or indirectly hits one of the end plates with its cover plate. Then a second energy absorption area from which force can then be transmitted to the other end plate by way of the elastic means is attached to the other end region.

In this connection, it is advantageous for the elastic means to be made as a spring which surrounds the cylindrical region and which is supported on the end ring which surrounds the cylindrical segment. This spring can be made as a cup spring or helical spring.

In this connection, it is useful for the spring to transmit a force to the second end plate by its being supported on a movable thrust ring which surrounds the cylindrical segment of the energy transmission element and which is supported on its side facing away from the spring on the second end plate. The distance between the end ring and the second end plate therefore need not be completely bridged by the spring. Rather, it is possible to bridge especially the path between the end ring and the end plate facing the second end plate by a thrust ring.

It is preferred that the energy transmission element consists at least predominantly of electrically insulating material. Preferably, ceramic insulation material is used. This ensures that the tie rod does not electrically short-circuit the stack. Due to the low thermal conductivity of the electrically insulating elements, it is furthermore ensured that excess heat is not transported by way of the tie rods into the areas in which this heat would be a disadvantage.

But, it can also be provided that the energy transmission element is made at least predominantly of metal and that there are insulation means for insulating the energy transmission element against electrically conductive areas of the fuel cell stack or against the end plates. This approach is more economical than the approach with a ceramic tie rod. The insulation means can be implemented, for example, as a ring of ceramic material which is located between the cover plate of the tie rod and the pertinent end plate.

In especially advantageous embodiments of this invention, it is provided that the end ring is axially adjustable so that the force applied by the elastic means can be varied. This varation can be useful both in the initial setting of the force which is to be applied and also in late maintenance work, for example, when after certain operating times of the fuel cell the mechanical ratios of the fuel cell arrangement change, especially as a result of the high process temperatures which continuously occur.

It is especially advantageous for the fuel cell arrangement to comprise a housing which has heat insulation on its inside. In this way, it can be ensured that components which surround the fuel cell arrangement or components of the fuel cell arrangement which are located outside the housing do not suffer undesirably from increased heat supply.

It is preferred that the energy transmission element is elastically connected to the housing. In this way, again, a damping property which is especially advantageous in particular for mobile applications is transmitted to the entire arrangement.

In this connection, it can be beneficial that the elastic connection of the energy transmission element to the housing comprises a cup spring which is connected to the energy transmission element and which is supported on the outside of the housing. Here, it can be considered especially advantageous for the cup spring to be located entirely outside of the housing which is provided with an insulating layer so that the cup spring is not influenced by the high temperatures which occur on the fuel cell stack. For this reason, the cup spring can be produced from economical materials, since it need not be able to maintain its elastic properties at high temperatures.

It is advantageously provided that the end ring has two parts and that the connection of the cup spring to the energy transmission element takes place by pressing the cup spring in between the parts of the end ring. This is a reliable and economical attachment possibility of the cup spring to the tie rod.

Furthermore, it is advantageous, for transmitting force to the end plates, for the elastic means to be located outside the housing. In turn, this is associated especially with the fact that, in this way, the elastic means, i.e., especially the spring between the end ring and the thrust ring, can lie in a relatively cold area so that economical materials can also be used for these springs.

It is likewise advantageous for the areas surrounding the fuel cell stack within the housing to be filled with fibrous insulation material. This provides further thermal insulation and is used at the same time as a damping means with respect to mechanical vibrations of the fuel cell stack.

The fuel cell arrangement is made in an especially advantageous manner such that there are three through openings and three energy transmission elements assigned to these three through openings. In this way, the fuel cell stack is exposed to force at several points; this improves overall stability. Providing three action points on each side of the fuel cell stack results in especially low stresses due to the action of the tie rod since the three action points, in any case, define a plane which can be adapted to the fuel cell stack in its position.

Furthermore, the invention relates to a device for mounting a fuel cell arrangement on a housing, especially a fuel cell arrangement in accordance with the invention, the device being characterized in that the fuel cell arrangement is connected to the housing by way of an element which is connected to the fuel cell stack using elastic means. This device can be used both for energy transmission means with elastic means, and for example, also in rigid bracing means.

The invention is based on the finding that high mechanical stability which is especially suited to counteracting vibrations can be imparted to the fuel cell arrangement by the transmission of force to the stack ends by elastic means. The fuel cell arrangement is simple to mount, and it can be produced from economical materials. Since it is a closed system, separation of the exhaust gas flows remains possible so that exhaust gas and exhaust air are not immediately burned. Moreover, this invention provides a flexible system coupling. Since the elasticity of the arrangement necessary for vibration damping is provided by the elastic means to the energy transmission means, permanent, very tight seals can be used in the system, for which providing compressibility does not matter. Consequently, good sealing properties can be transmitted to the system. Production and maintenance of the arrangement are simplified or improved in that it is possible to change the force applied to the fuel cell stack by an axially movable end ring.

At this point, the invention will be explained by way of example with reference to the accompanying drawing using one preferred embodiment.

### BRIEF DESCRIPTION OF THE DRAWINGS

The sole FIGURE is a sectional view of part of the fuel cell arrangement in accordance with the invention.

### DETAILED DESCRIPTION OF THE INVENTION

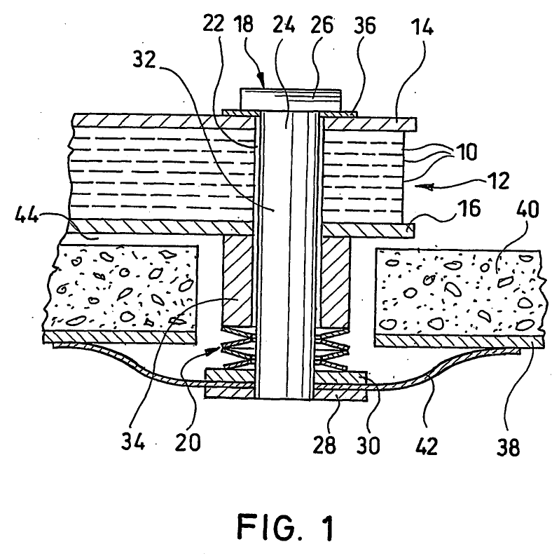

FIG. 1 shows a sectional view of part of the fuel cell arrangement in accordance with the invention which has plurality of fuel cells 10 which, together, form a fuel cell stack 12 which is bordered on an upper end of the fuel cell stack by an upper end plate 14 and on a lower end by a lower end plate 16. The arrangement composed of the lower end plate 16, the fuel cell stack 12 and the upper end plate 14 is provided with a through opening 22 which, in this embodiment, has an at least almost constant diameter over its entire length.

A tie rod 24 equipped with a cover plate 26 is inserted into through opening 22 as part of an energy transmission means 18. The tie rod 24, in this exemplary embodiment, is provided with an essentially cylindrical segment 32 which is located partially within the through opening 22. This can be recommended for a cylindrical through opening. But, other exemplary embodiments are also conceivable in which the tie rod has a differently shaped outside contour, for example, also outside the through opening 22. The tie rod 24 can rest with its cover plate 26 either directly on the upper end plate 14, or as shown in this case, on an insulating disk 36; this is especially useful when the tie rod 24 is made of electrically conductive material. The insulating disk 36 is not necessary when the tie rod 24 is made of electrically insulating material, for example, an electrically insulating ceramic. On the lower end of the tie rod 24, it is equipped with an end ring, which is made in two parts 28, 30, in this exemplary embodiment. A spring 20 is supported on the end ring 28, 30, and on its other side, applies a force to a thrust ring 34. This thrust ring 34, for its part, applies a force to the lower end plate 16. Thus, forces which are directed opposite one another are applied to the two end plates 14, 16.

Between the two parts 28, 30 of the two-part end ring, a cup spring 42 is attached which thus is tightly connected to the energy transmission means 18. The energy transmission means 18 is supported by way of this cup spring 42 on the outside wall of the housing 38 of the fuel cell arrangement. Thus, not only is the fuel cell stack 12 with the end plates 14, 16, elastically exposed to force, but the entire arrangement including the energy transmission means 18 is also elastically attached to the housing 38. The housing 38, on its inside, is equipped with heat insulation 40 in order, in this way, to avoid undue heat radiation from the fuel cell stack 12 into the outer region of the housing 38.

The cup spring 42 and at least in part the spring 20 are located in the region outside of the housing 38 so that these components can be produced from economical material which need not have special heat resistance, in particular, with respect to its elastic properties. In other regions of the housing 38, especially in the areas 44 between the heat insulation 40 and the end plates 14, 16, of the fuel cell stack 12, there is preferably fibrous insulating material in order to provide additional heat insulation in this way, and furthermore, additional damping of mechanical vibrations of the system.

While only the single through opening 22 and energy transmission element 18 is shown in the drawings, it is noted that the fuel cell arrangement is made in an especially advantageous manner such that there are three such through openings 22 and three such energy transmission elements 18, each of which assigned to a respective one of these three through openings 22. In this way, the fuel cell stack 12 is exposed to force at several points; this improves overall stability. Providing three action points on each side of the fuel cell stack 12 results in especially low stresses due to the action of the tie rod since the three action points, in any case, define a plane which can be adapted to the fuel cell stack in its position.

Within the framework of the description of this invention, the elastic support of the energy transmission means 18, and thus, of the fuel cell stack 12 on the housing 38, by means of a cup spring 42 has been described in conjunction with the energy transmission of the invention, with the inclusion of elastic means 20. In this connection, it is noted that the elastic support can also be useful even detached from the special energy transmission means 18 of the invention, for example, in conjunction with bracing means which transmit the force to the fuel cell stack without special elastic means.

The features of the invention disclosed in the description above and in the drawings can be significant to the implementation of the invention both individually and also in any combination.

What is claimed is:

1. Fuel cell arrangement with
a fuel cell stack (12) having a plurality fuel cells (10),
a first (14) and a second end plate (16) which border the fuel cell stack (12) on respective ends of the stack, and
at least one energy transmission means (18) which transmits a first force to the first end plate (14) in a direction toward the second end plate (16) and a second force to the second end plate (16) in a direction toward the first end plate (14), said at least one energy transmission means comprising an elastic means.

2. Fuel cell arrangement as claimed in claim 1, wherein
the fuel cell stack (12) and the end plates (14, 16) have at least one through opening (22) which extends essentially perpendicular to the end plates,
wherein, in at least one through hole (22), there is an energy transmission element (24) which has an area that projects beyond the first and second end plates,
wherein the energy transmission element (24) has or is connected to a first energy absorption area on the area projecting beyond the first end plate, and
wherein the energy transmission element (24), on the area projecting beyond the second end plate, has or is connected to a second energy absorption area (28, 30) which applies a force to the second end plate (16) by way of the elastic means (20).

3. Fuel cell arrangement as claimed in claim 2, wherein
the energy transmission element (24) has an essentially cylindrical segment (32) which is located partially within the through opening (22),
wherein the first energy absorption area is a cover plate (26) of the cylindrical segment (32) and has a greater radius than the through opening (22) through the first end plate (14), and
wherein the second energy absorption area is an end ring (28, 30) which surrounds the cylindrical segment (32) and which is connected to the cylindrical segment.

4. Fuel cell arrangement as claimed in claim 3, wherein the elastic means comprises a spring (20) which surrounds the cylindrical region and which is supported on the end ring (28, 30) which surrounds the cylindrical segment (32).

5. Fuel cell arrangement as claimed in claim 4, wherein the spring (20) transmits force to the second end plate (16) by its being supported on a movable thrust ring (34) which surrounds the cylindrical segment (32) of the energy transmission element and which is supported on its side facing away from the spring on the second end plate (16).

6. Fuel cell arrangement as claimed in claim 2, wherein the energy transmission element (24) is formed, at least predominantly, of electrically insulating material.

7. Fuel cell arrangement as claimed claim 2, wherein
the energy transmission element (24) is formed at least predominantly of metal and
insulation means (36) is provided for insulating the energy transmission element (24) against electrically conductive areas of the fuel cell stack (12) or the end plates (14, 16).

8. Fuel cell arrangement as claimed in claim 3, wherein the end ring (28, 30) is axially adjustable for varying the force applied by the elastic means.

9. Fuel cell arrangement as claimed in claim 1, wherein the fuel cell arrangement comprises a housing (38) which has heat insulation (40) on its inside.

10. Fuel cell arrangement as claimed in claim 9, wherein the energy transmission element (24) is elastically connected to the housing (38).

11. Fuel cell arrangement as claimed in claim 10, wherein the elastic connection of the energy transmission element (24) to the housing (38) comprises a cup spring (42) which is connected to the energy transmission element (24) and which is supported on the outside of the housing (38).

12. Fuel cell arrangement as claimed in claim 11, wherein
the end ring (28, 30) is made in two parts and
wherein the connection of the cup spring (42) to the energy transmission element (24) takes place the cup spring (42) being pressed in between the parts of the end ring (28, 30).

13. Fuel cell arrangement as claimed in claim 9, wherein the elastic means (20) for transmitting force to the end plates (14, 16) is located outside the housing (38).

14. Fuel cell arrangement as claimed in claim 9, wherein areas (44) surrounding the fuel cell stack within the housing (38) are filled with fibrous insulation material.

15. Fuel cell arrangement as claimed in claim 2, wherein there are three through openings (22) and three energy transmission elements (24), a respective one of the three energy transmission elements being in each of the three through openings.

16. Device for mounting a fuel cell arrangement on a housing (38), wherein the fuel cell arrangement comprises:
a fuel cell stack having a plurality fuel cells
a first and a second end plate which border the fuel cell stack on respective ends of the stack, and
at least one energy transmission means which transmits a first force to the first end plate in a direction toward the second end plate and a second force to the second end plate in a direction toward the first end plate, said at least one energy transmission means comprising an elastic means;
wherein the fuel cell arrangement is connected to the housing (38) by way of an element (24) which is connected to the fuel cell stack (12) using elastic means.
